(19) United States
(12) Patent Application Publication
(10) Pub. No.: US 2010/0193266 A1
(43) Pub. Date: Aug. 5, 2010

(54) Power Supply Apparatus And Electric Vehicle

(75) Inventors: Kazuhiro Seo, Osaka (JP); Hiroshi Abe, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/597,871

(22) PCT Filed: Apr. 28, 2008
(86) PCT No.: PCT/JP2008/058150

§ 371 Date: Mar. 1, 2010

(30) Foreign Application Priority Data
Apr. 27, 2007 (JP) 2007119249
Apr. 25, 2008 (JP) 2008116302

(51) Int. Cl. B60K 1/00; B60L 1/00

(52) U.S. Cl. 180/65.1; 307/80; 307/9.1

(57) ABSTRACT

A power supply apparatus 100 provided with a plurality of electric storage devices V1 to V3 connected in parallel, comprising a temperature detector configured to detect a temperature of each of the plurality of electric storage devices V1 to V3; a switching element connected to each of the plurality of electric storage devices V1 to V3 in series; and a controller configured to control an on-state and an off-state of the switching element, wherein the controller sets the switching element to the off-state when the temperature detected by the temperature detector is higher than a predetermined temperature.

### TECHNICAL FIELD

The present invention relates to a power supply apparatus configured to use multiple electric storage devices connected in parallel, and to an electric vehicle including the power supply apparatus.

### BACKGROUND ART

There has conventionally been proposed a high-voltage and large-capacity power supply apparatus having multiple electric storage devices either connected in series or connected in parallel. FIG. 1 is a circuit diagram of a power supply apparatus 100 in which multiple electric storage devices V1 to V3 are connected in parallel. In the power supply apparatus 100 of FIG. 1, the conventional electric storage devices V1 to V3 having different internal resistances R1 to R3, respectively, are connected in parallel and supply electric power to a load 10.

Since the internal resistances R1 to R3 of the respective electric storage devices V1 to V3 in FIG. 1 are different, currents flowing through the respective electric storage devices V1 to V3 are also different from one another. Here, a calorific value J of an electric storage device V is J=RI² (R is the internal resistance of the electric storage device V, and I is the current flowing through the electric storage device V). Accordingly, since the internal resistances R1 to R3 of the respective electric storage devices V1 to V3 are different, calorific values J1 to J3 of the respective electric storage devices V1 to V3 are also different from one another. Meanwhile, the internal resistances of the electric storage devices vary depending on conditions of use of the electric storage devices (such as battery capacities or temperatures of the electric storage devices V) and on the individual differences among the individual electric storage devices. For this reason, it is not possible to preset the internal resistances of the electric storage devices.

Therefore, the power supply apparatus of this type has a problem of an increase in the current flowing through an electric storage device having a small internal resistance, which leads to abnormal heat generation of the electric storage device having the small internal resistance. Moreover, since the currents flowing through the respective electric storage devices V1 to V3 are different, there is also a problem that the temperatures of the respective devices V1 to V3 vary from one another. For example, if abnormal heat generation occurs in a certain electric storage device, there arises a case where power supply to the load 10 needs to be restricted or stopped though the other electric storage devices are normal. Moreover, since the electric storage devices are apt to deteriorate at high temperatures, the variation in temperature among the electric storage devices V1 to V3 causes variation in deterioration. As a consequence, the lifetime characteristic of the power supply apparatus is degraded because the power supply apparatus comes to the end of its life when the most rapidly deteriorated electric storage device comes to the end of its life.

Regarding these problems, JP-A 2004-31255 discloses a method of suppressing variation in temperature among electric storage devices (cells) in a case of knowing in advance the configuration of a power supply apparatus and a temperature rise tendency (an environmental temperature) exerted on the electric storage devices by an instrument mounted with the power supply apparatus. This method is accomplished by connecting output terminals of the power supply apparatus to connection resistances or PTCs (positive temperature coefficients) having mutually different temperature rise tendencies.

### DISCLOSURE OF THE INVENTION

However, the above-mentioned conventional method causes a problem that the variation in temperature among the cells cannot be suppressed unless the configuration of the power supply apparatus or the environmental temperature is known.

The present invention has been made in view of the above-described contents, and provides a power supply apparatus provided with a plurality of electric storage devices connected in parallel, comprising: a temperature detector configured to detect a temperature of each of the plurality of electric storage devices; a switching element connected to each of the plurality of electric storage devices in series; and a controller configured to control an on-state and an off-state of the switching element, wherein the controller sets the switching element to the off-state when the temperature detected by the temperature detector is higher than a predetermined temperature.

In addition, the present invention provides a power supply apparatus provided with a plurality of electric storage devices connected in parallel, comprising: a temperature detector configured to detect a temperature of each of the plurality of electric storage devices; a switching element connected to each of the plurality of electric storage devices in series; and a controller configured to control an on-state and an off-state of the switching element, wherein the controller outputs a PWM signal to the switching element on the basis of the temperature detected by the temperature detector, and sets the switching element to the on-state or the off-state in response to a high-state and a low-state of the PWM signal.

Additionally, the present invention provides a power supply apparatus provided with a plurality of electric storage devices connected in parallel, comprising: a current detector configured to detect a current flowing through each of the plurality of electric storage devices; a voltage detector configured to detect a voltage of each of the plurality of electric storage devices; a switching element connected to each of the plurality of electric storage devices in series; and a controller configured to output a PWM signal to the switching element on the basis of the current detected by the current detector and the voltage detected by the voltage detector, and to set the switching element to the on-state or the off-state in response to a high-state and a low-state of the PWM signal.

Moreover, the present invention provides the power supply apparatus, wherein the controller outputs the PWM signal having a duty cycle corresponding to an internal resistance of each of the plurality of electric storage devices, on the basis of the current detected by the current detector and the voltage detected by the voltage detector.

Further, the present invention provides the power supply apparatus, wherein at least one of the plurality of electric storage devices formed of a plurality of electric storage devices connected in series.

Furthermore, the present invention provides an electric vehicle comprising: the power supply apparatus according to any of claims 1 to 5; an electric motor configured to generate motive power by use of electric power supplied by the power supply apparatus; and a driving wheel to which the motive power is transmitted.

Moreover, the present invention provides a power supply module formed by serially connecting the power supply apparatuses of the present invention.

There is provided a power supply system including the above-described power supply module, a temperature detector configured to detect a temperature of the power supply module, a switching element connected to the power supply module in series, and a controller configured to control an on-state and an off-state of the switching element, wherein the controller sets the switching element to the off-state when the temperature detected by the temperature detector is higher than a predetermined temperature.

There is provided a power supply system including the above-described power supply module, a current detector configured to detect a current flowing through the power supply module, a voltage detector configured to detect a voltage on the power supply module, a switching element connected to the power supply module in series, and a controller configured to output a PWM signal to the switching element based on the current detected by the current detector and on the voltage detected by the voltage detector and to set the switching element to the on-state and the off-state in response to a high-state and a low state of the PWM signal.

By providing the above-described configurations, it is possible to suppress variation in temperature among the respective electric storage devices even if the configuration of the power supply apparatus or the environmental temperature is unknown.

### BRIEF DESCRIPTION OF THE DRAWINGS

FIG. 1 is a circuit diagram showing a case of connecting multiple electric storage devices V1 to V3 in parallel.

FIG. 2 is a circuit diagram showing Example 1 of a power supply apparatus of the present invention.

FIG. 3 is a view showing a temperature characteristic of a PTC 3.

FIG. 4 is a circuit diagram showing Example 2 of the power supply apparatus of the present invention.

FIG. 5 is a view showing a temperature characteristic of a thermistor 5.

FIG. 6 is a circuit diagram showing Example 3 of the power supply apparatus of the present invention.

FIG. 7 is a circuit diagram showing Example 4 of the power supply apparatus of the present invention.

FIG. 8 is a view showing a control flow when using Example 4.

FIG. 9 is a circuit diagram showing Example 5 of the power supply apparatus of the present invention.

FIG. 10 is a view showing a control flow when using Example 5.

FIG. 11 is a configuration diagram of an electric vehicle 200 according to Example 6 of the present invention.

FIG. 12 is a circuit diagram concerning Example 4 using multiple electric storage devices which are connected in series.

FIG. 13 is a circuit diagram for verifying an operation of a switching element.

FIG. 14 is a view showing a measurement result of an outputted current value from an electric storage device V1.

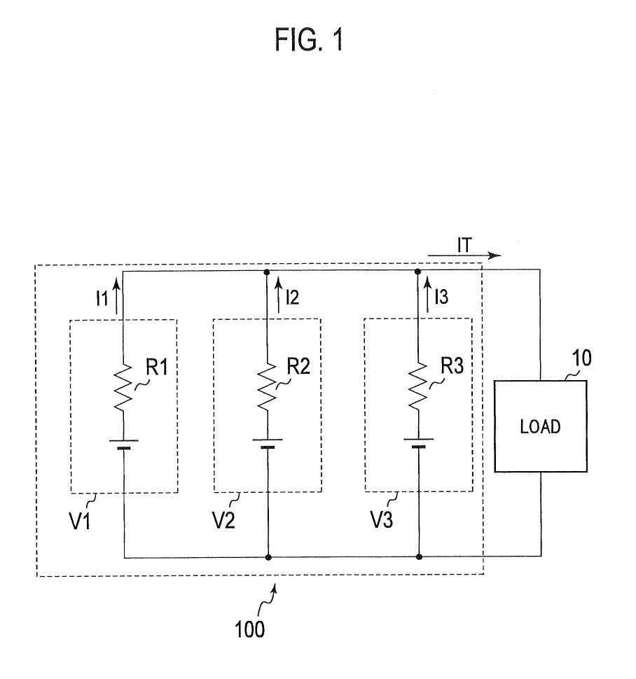

### BEST MODES FOR CARRYING OUT THE INVENTION

The meanings and effects of the present invention will become more apparent by the following description of an embodiment. It is to be noted, however, that the following embodiment is merely one embodiment of the present invention and that the present invention or the meanings of each constituent feature will not be limited to the following description of the embodiment.

### Example 1

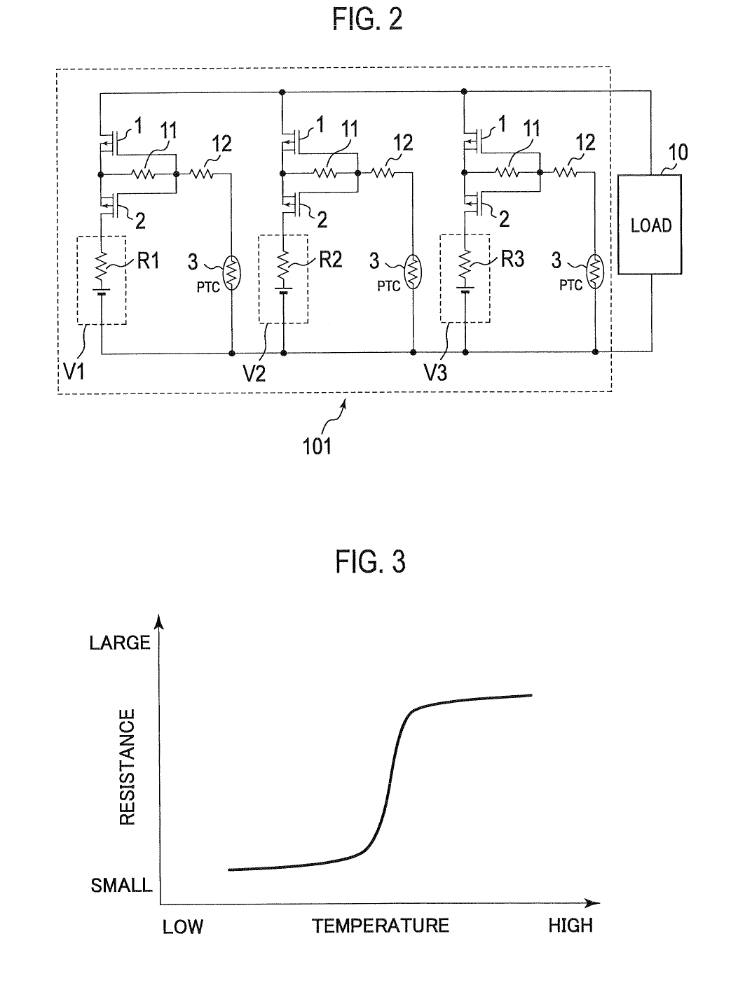

FIG. 2 is a circuit diagram showing Example 1 of a power supply apparatus of the present invention. A power supply apparatus 101 is provided with electric storage devices V1, V2, and V3, FETs (field effect transistors) 1 and 2 as switching elements, a PTC 3 as a temperature detector, and resistances 11 and 12. Since each of the electric storage devices V1 to V3 applies a similar circuit, the electric storage device V1 will be described below.

As shown in FIG. 2, the FET1 is connected to one end of the resistance 11 and to a source side of the FET 2. Meanwhile, a drain side of the FET 1 is connected to a load 10 and the other electric storage devices V2 and V3. Meanwhile, a gate side of the FET 1 is connected to the other end of the resistance 11 and to one end of the resistance 12.

A source side of the FET 2 is connected to the one end of the resistance 11 and to the source side of the FET 1. Meanwhile, a drain side of the FET 2 is connected to a positive electrode side of the electric storage device V1. Meanwhile, a gate side of the FET 2 is connected to the other end of the resistance 11 and to the one end of the resistance 12.

The PTC 3 is disposed so as to be influenced by the temperature of the electric storage device V1. For example, the PTC 3 may be attached to the electric storage device V1. One end of the PTC 3 is connected to the other end of the resistance 12 and the other end thereof is connected to a negative electrode side of the electric storage device V1. Meanwhile, as shown in a temperature characteristic of the PTC 3 in FIG. 3, the PTC 3 has a characteristic that its resistance shows a sharp rise when the temperature exceeds a predetermined value.

Accordingly, in the circuit of Example 1, the resistance of the PTC 3 becomes low when the temperature of the electric storage device V1 is low. For this reason, the currents flow between the gates and the sources of the FETs 1 and 2 so that the currents also flow between the sources and the drains of the FETs 1 and 2. That is, the FETs 1 and 2 are set to an on-state when the temperature of the electric storage device V1 is low. Meanwhile, when the electric storage device V1 generates heat, the resistance of the PTC 3 rises and reaches the predetermined temperature (a trip temperature). Then, the current stops flowing between the gates and the sources of the FETs 1 and 2. Accordingly, the currents flowing between the drains and the sources of the FETs 1 and 2 are disconnected. In other words, the FETs 1 and 2 are set to an off-state when the temperature of the electric storage device V1 is high. In this way, the FETs 1 and 2 serving as the switching elements are controlled. Note that, the PTC 3 plays a role as the controller. Here, the temperature at which the restriction of the currents flowing through the electric storage devices is started as a result of the temperature rise is referred to as the trip temperature. On the other hand, a temperature at which the restriction of the currents flowing through the electric storage devices is released as a result of a temperature drop is referred to as a return temperature.

Meanwhile, a safely operable temperature for each of the electric storage devices V and instruments for use is set up. Accordingly, when selecting the PTC for use, the one configured to sharply raise the resistance value at a temperature lower than the set-up level is selected in light of safety. For example, if the safely operable temperature of the electric storage device V is 80° C., then the PTC 3 configured to sharply raise the resistance value at 70° C. is used.

As described above, the PTC 3 detects the temperature of the electric storage device V1, and the FETs 1 and 2 are set to the off-state when the temperature becomes the trip temperature or more, whereby the current stops flowing through the electric storage device V1. Accordingly, it is possible to suppress the temperature rise of the electric storage device V1 irrespective of an influence by the environmental temperature or a change in an internal resistance value R1 of the electric storage device V1 attributable to aged deterioration of the electric storage device V1.

Moreover, this circuit is similarly applied to the other electric storage devices V2 and V3 which are connected in parallel. If the temperature of each of the electric storage devices V1 to V3 rises, the FETs 1 and 2 of each of the electric storage devices V1 to V3 are set to the off-state. Hence it is possible to avoid concentration of a load (such as the current) on the electric storage device V having a smaller internal resistance R, and thereby to homogenize the temperatures among the respective electric storage devices V1 to V3.

Meanwhile, the electric storage device V1 in which the FETs 1 and 2 are set to the on-state (i.e., when the currents are flowing between the drains and sources thereof) is operable even if the FETs 1 and 2 are set to the off-state due to the temperature rise of the other electric storage devices V2 and V3, and is therefore able to supply electric power to the load 10.

Meanwhile, the current to the load 10 is prevented from flowing directly through the PTC 3. Accordingly, the power supply apparatus 101 is applicable to a system such as an EV (Electric Vehicle) or a HEV (Hybrid Electric Vehicle) in which a large current flows.

### Example 2

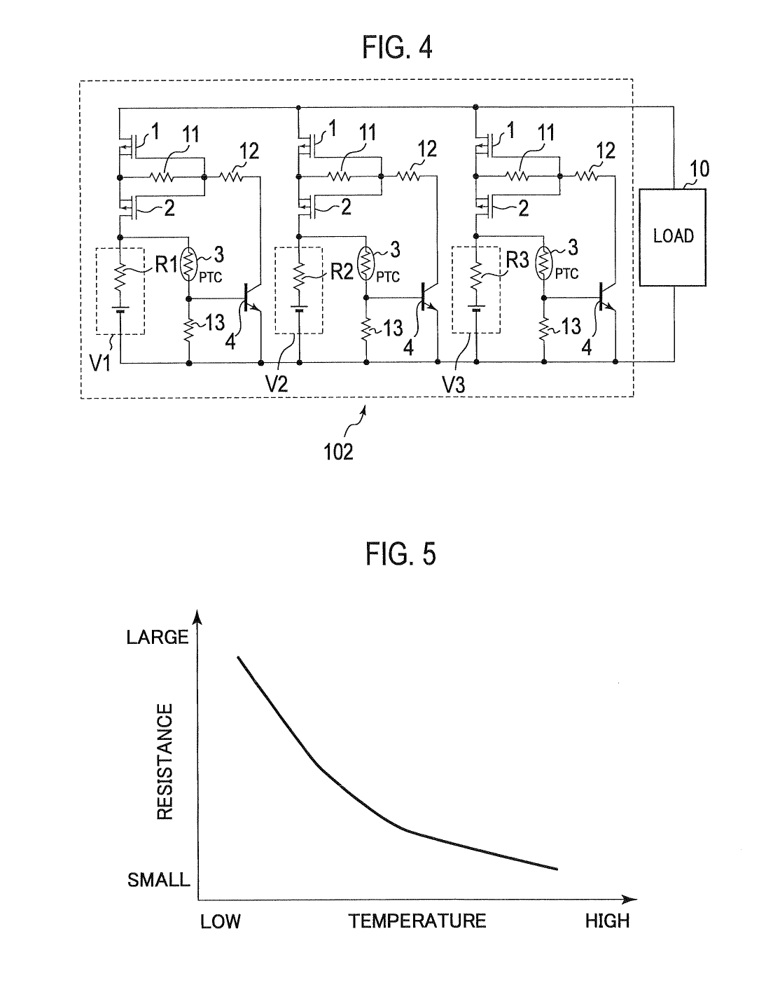

A method of using a bipolar transistor 4 according to Example 2 will be described by using FIG. 4. Moreover, since the respective electric storage devices V1 to V3 use a similar circuit, the device V1 will be described below.

FIG. 4 is a circuit diagram showing Example 2 of the power supply apparatus of the present invention. A power supply apparatus 102 is different from Example 1 in that the power supply apparatus 102 applies bipolar transistors 4 and resistances 13 and that the PTC 3 is connected in a different manner.

One end of the PTC 3 is connected to the positive electrode side of the electric storage device V1 and to the drain side of the FET 2. Meanwhile, the other end of the PTC 3 is connected to one end of the resistance 13 and to a base side of the bipolar transistor 4.

A collector side of the bipolar transistor 4 is connected to the other end side of the resistance 12. Meanwhile, an emitter side of the bipolar transistor 4 is connected to the other end of the resistance 13 and to the negative electrode side of the electric storage device V1. Meanwhile, the base side of the bipolar transistor 4 is connected to the other end of the PTC 3 and to the one end of the resistance 13.

By applying this configuration, when the temperature of the electric storage device V1 is low, the resistance of the PTC 3 is low. Thus, the current flows between the base and the emitter of the bipolar transistor 4 and the current also flows between the collector and the emitter of the bipolar transistor 4. That is, when the temperature of the electric storage device V1 is low, the bipolar transistor 4 is set to the on-state. Then, the currents also flow between the gates and the sources of the FETs 1 and 2 so that the currents also flow between the drains and the sources of the FETs 1 and 2 (i.e., the FETs 1 and 2 are set to the on-state).

Meanwhile, when the temperature of the electric storage device V1 rises and reaches the predetermined temperature (the trip temperature), the resistance of the PTC 3 rises sharply so that the current flowing between the base and the emitter of the bipolar transistor 4 is eliminated. Accordingly, the current flowing between the collector and the emitter of the bipolar transistor 4 is disconnected. In other words, when the temperature of the electric storage device V1 rises, the bipolar transistor 4 is set to the off-state. When the bipolar transistor 4 is set to the off-state, the currents do not flow between the gates and the sources of the FETs 1 and 2 (i.e., the FETs 1 and 2 are set to the off-state). In this way, the FETs 1 and 2 serving as the switching elements are controlled (note that the PTC 3 and the bipolar transistor 4 play a role as the controller).

Meanwhile, the safely operable temperature for each of the electric storage devices V and the instruments for use is set up. Accordingly, when selecting the PTC for use, the one configured to sharply raise the resistance value at a temperature lower than the set-up level is selected in light of safety. For example, if the safely operable temperature of the electric storage device V is 80° C., then the PTC 3 configured to sharply raise the resistance value at 70° C., for example, is used.

As described above, the PTC 3 detects the temperature of the electric storage device V1 and the bipolar transistor 4 is set to the off-state so as to set the FETs 1 and 2 to the off-state when the temperature becomes the trip temperature or more. The current stops flowing through the electric storage device V1 when the FETs 1 and 2 are set to the off-state. Accordingly, it is possible to suppress the temperature rise of the electric storage device V1 irrespective of the influence by the environmental temperature or the change in the internal resistance value R1 of the electric storage device V1 attributable to aged deterioration of the electric storage device V1.

Moreover, this circuit is similarly applied to the other electric storage devices V2 and V3 which are connected in parallel. If the temperature of each of the electric storage devices V1 to V3 rises, the FETs 1 and 2 of each of the electric storage devices V1 to V3 are set to the off-state. Hence it is possible to avoid concentration of the load (such as the current) on the electric storage device V having the smaller internal resistance R and thereby to homogenize the temperatures among the respective electric storage devices V1 to V3.

Meanwhile, the electric storage device V1 in which the FETs 1 and 2 are set to the on-state (i.e., when the currents are flowing between the drains and sources thereof) is operable even if the FETs 1 and 2 of the other electric storage devices V2 and V3 are set to the off-state due to the temperature rise, and is therefore able to supply electric power to the load 10.

Meanwhile, the current to the load 10 is prevented from flowing directly through the PTC 3. Accordingly, the power supply apparatus 102 is applicable to a system such as an EV (Electric Vehicle) or a HEV (Hybrid Electric Vehicle) in which a large current flows.

### Example 3

The above-described Example 1 and Example 2 show the case of using the PTC 3 configured to increase the resistance along with the temperature rise. Meanwhile, Example 3 will describe a case of using a thermistor 5 configured to reduce resistance along with the temperature rise as shown in a temperature characteristic of the thermistor 5 in FIG. 5. Note that a NTC is used as the thermistor 5 in this Example 3. Moreover, since the respective electric storage devices V1 to V3 use a similar circuit, the device V1 will be described below.

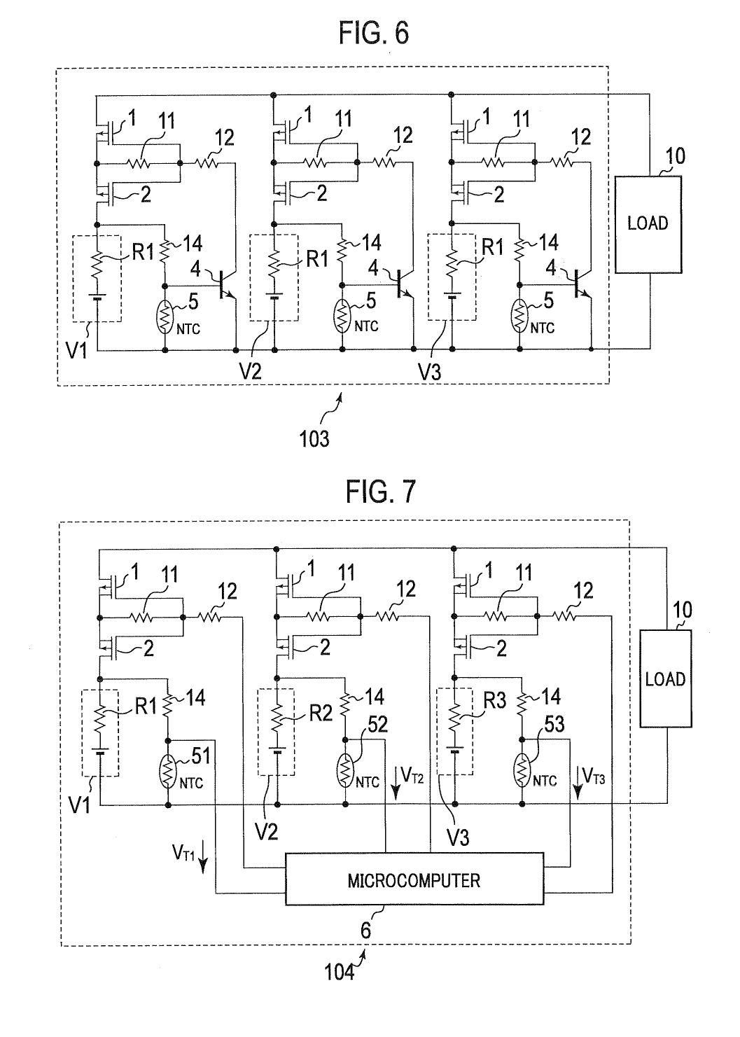

FIG. 6 is a circuit diagram showing Example 3 of the power supply apparatus of the present invention. A power supply apparatus 103 is different from Example 2 in that a resistance 14 is disposed in the position of the PTC 3 and that the thermistor 5 is disposed in the position of the resistance 13.

By applying this configuration, when the temperature of the electric storage device V1 is low, the resistance of the thermistor 5 becomes so high that the current flows between the base and the emitter of the bipolar transistor 4, and the current also flows between the collector and the emitter of the bipolar transistor 4. That is, when the temperature of the electric storage device V1 is low, the bipolar transistor 4 is set to the on-state. Then, the currents also flow between the gates and the sources of the FETs 1 and 2 so that the currents also flow between the drains and the sources of the FETs 1 and 2 (i.e., the FETs 1 and 2 are set to the on-state).

Meanwhile, when the temperature of the electric storage device V1 rises and reaches the predetermined temperature (the trip temperature), the resistance of the thermistor 5 is reduced so that the current flowing between the base and the emitter of the bipolar transistor 4 is eliminated. Accordingly, the current flowing between the collector and the emitter of the bipolar transistor 4 is disconnected. In other words, when the temperature of the electric storage device V1 rises, the bipolar transistor 4 is set to the off-state. When the bipolar transistor 4 is set to the off-state, the currents do not flow between the gates and the sources of the FETs 1 and 2 (i.e., the FETs 1 and 2 are set to the off-state). In this way, the FETs 1 and 2 serving as the switching elements are controlled. Note that the thermistor 5 and the bipolar transistor 4 play a role as the controller.

Meanwhile, the safely operable temperature for each of the electric storage devices V and instruments for use is set up. Accordingly, when selecting the thermistor for use, a thermistor configured to sharply raise the resistance value at a temperature lower than the set-up level may be selected in light of safety. For example, if the safely operable temperature of the electric storage device V is 80° C., then the thermistor configured to substantially disconnect the current flowing through the thermistor at 70° C., for example, is selected.

As described above, the thermistor 5 detects the temperature of the electric storage device V1 and the bipolar transistor 4 is set to the off-state so as to set the FETs 1 and 2 to the off-state when the resistance of the thermistor 5 becomes low. The current stops flowing through the electric storage device V1 when the FETs 1 and 2 are set to the off-state. Accordingly, it is possible to suppress the temperature rise of the electric storage device V1 irrespective of the influence by the environmental temperature or the variation in the internal resistance value R1 of the electric storage device V1 attributable to aged deterioration of the electric storage device V1.

Moreover, this circuit is similarly applied to the other electric storage devices V2 and V3 which are connected in parallel. If the temperature of each of the electric storage devices V1 to V3 rises, the FETs 1 and 2 of each of the electric storage devices V1 to V3 are set to the off-state. Hence it is possible to avoid concentration of the current on the electric storage device V having the smaller internal resistance R and thereby to homogenize the temperatures among the respective electric storage devices V1 to V3.

Meanwhile, the electric storage device V1 in which the FETs 1 and 2 are set to the on-state (i.e., when the currents are flowing between the drains and sources thereof) is operable even if the FETs 1 and 2 of the other electric storage devices V2 and V3 are set to the off-state due to the temperature rise, and is therefore able to supply electric power to the load 10.

Meanwhile, the current to the load 10 is prevented from flowing directly through the thermistor 5. Accordingly, the power supply apparatus 103 is applicable to a system such as an EV (Electric Vehicle) or a HEV (Hybrid Electric Vehicle) in which a large current flows.

### Example 4

Example 4 will describe a case of using a microcomputer as the controlling means instead of using the bipolar transistor 4 as in Example 3.

FIG. 7 is a circuit diagram showing Example 4 of the power supply apparatus of the present invention. Electric storage devices V1 to V3 of a power supply apparatus 104 are provided with thermistors 51 to 53. Moreover, the power supply apparatus 104 is provided with the microcomputer 6. Voltages V_{T1} to V_{T3} of the thermistors 51 to 53 are measured with the microcomputer 6. Values of temperatures T1 to T3 of the electric storage devices V1 to V3 can be obtained from the measured voltages V_{T1} to V_{T3} of the thermistors 51 to 53 and characteristics (FIG. 5) of the thermistors 51 to 53. Meanwhile, the microcomputer 6 serving as the controlling means performs PWM (Pulse Width Modulation) control based on the obtained temperatures T1 to T3. Note that NTCs are used as the thermistors 51 to 53 in this Example 4.

The PWM control is the control based on a signal having a predetermined frequency and a duty cycle. Usually, a signal alternating a high-state and a low-state (i.e., a high/low signal) is used as this signal. In this case, the predetermined frequency is determined by alternation of the high-state and the low-state and the duty cycle is defined as D=T_{ON}/(T_{ON}+T_{OFF}).

In the description of the present invention, this high/low signal will be referred to as a PWM signal.

This PWM signal is outputted to the switching elements and the on-state and the off-state of the switching elements are controlled so as to correspond to the high-state and low-state of this PWM signal.

Therefore, if the duty cycle is 100%, for example, the currents flowing through the electric storage devices continue to flow without restrictions. Meanwhile, as the duty cycle becomes smaller, the currents flowing through the electric storage devices will be more restricted. In the meantime, a correlation between the PWM signal and the on-state as well as the off-state of the FETs 1 and 2 may be set such that the signals at the high-state and the low-state respectively correspond to the on-state and the off-state of the FETs 1 and 2, or that that the signals at the high-state and the low-state respectively correspond to the off-state and the on-state of the FETs 1 and 2 in an opposite manner.

In Example 4, duty cycles D1 to D3 concerning the respective electric storage devices V1 to V3 are obtained based on the temperatures T1 to T3 of the electric storage devices V1 to V3 when the temperatures of the electric storage devices V1 to V3 reach a predetermined temperature TH, and thereby controls the currents flowing through the electric storage devices V1 to V3. Meanwhile, a safely operable temperature for each of the electric storage devices V and instruments for use is set up. Accordingly, it is preferable to set up a temperature lower than the safety operable temperature as the predetermined temperature. For example, if the safely operable temperature of the electric storage device V is 80° C., then the predetermined temperature is set to, for example, 70° C.

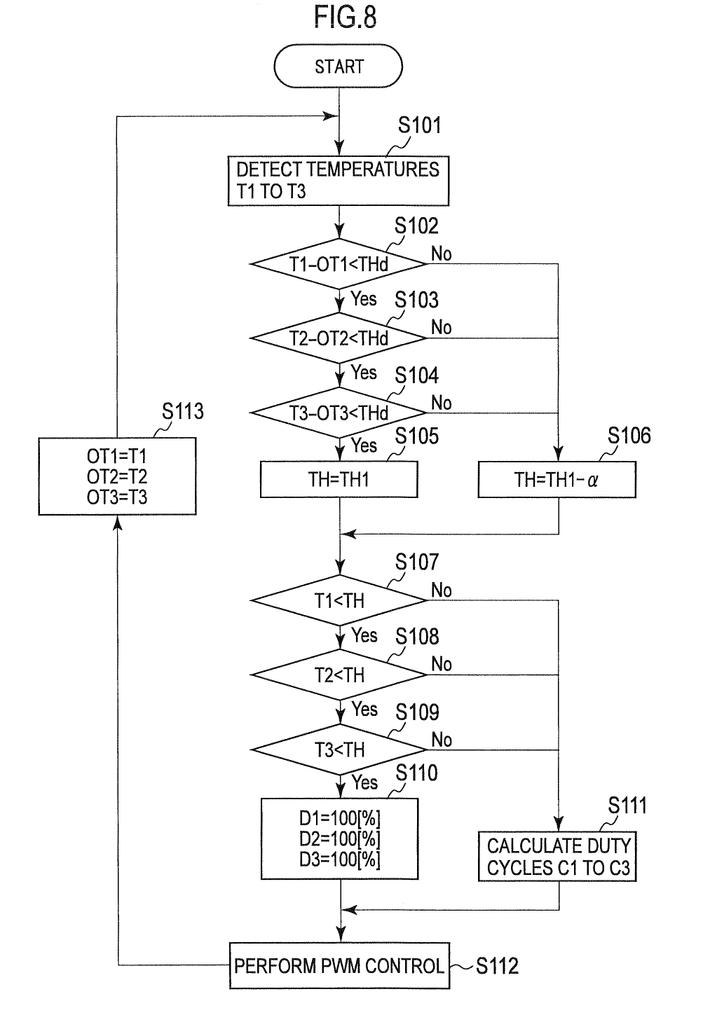

FIG. 8 shows a control flow when using Example 4. At a start, current temperature data T1 to T3 are recorded as past temperature data OT1 to OT3 of the electric storage devices V1 to V3 and the process goes to step S101. Values of the temperatures T1 to T3 are obtained in step S101. A difference between each of the obtained temperatures T1 to T3 and each of the past temperature data OT1 to OT3 is calculated and compared with a threshold THd indicating a predetermined temperature width (S102 to S104). The process goes to step S105 when all the differences are smaller than the threshold THd as a result of comparison. On the other hand, the process goes to step S106 if any one of the respective differences is greater than the threshold THd as a result of comparison.

In steps S105 and S106, the predetermined temperature for starting current restriction is determined in terms of each of the electric storage devices V1 to V3 based on the above-described temperature difference. In step S105, a judgment is made that there is no steep temperature changes and hence a predetermined trip temperature TH1 is determined as TH and then the process goes to step S107. In step S106, a judgment is made that there is a steep temperature change and hence a value obtained by subtracting a predetermined temperature α from the predetermined trip temperature TH1 is determined as TH and then the process goes to step S107.

In steps S107 to S109, the temperature TH determined in step S105 or S106 is compared with the current temperatures T1 to T3. The process goes to step S110 when all of T1 to T3 are lower than TH. On the other hand, the process goes to step S111 if any one of the current temperatures T1 to T3 is higher than the temperature TH. In step S110, a judgment is made that the temperatures T1 to T3 are in a sufficiently low-state and the PWM control of the FETs 1 and 2 is performed in step 112 while setting, all the duty cycles D1 to D3 of the FETs 1 and 2 respectively corresponding to the electric storage devices V1 to V3, to be 100% (i.e., without the current restriction). In step S111, a judgment is made that the temperatures T1 to T3 are in a high-state. Accordingly, the duty cycles D1 to D3 are calculated and the PWM control of the FETs 1 and 2 is performed by use of the duty cycles D1 to D3 calculated in step 112. Thereafter, the process goes to step S113. In step S113, the temperatures T1 to T3 are assigned to the respective past temperature data OT1 to OT3 and then the process returns to step S101.

Now, an example of a method of calculating the duty cycles C1 to C3 in step S111 will be described. In order to obtain the duty cycles D1 to D3, the lowest temperature TS is obtained by comparing the temperatures T1 to T3 and proportions are obtained by defining TS as a numerator while defining the temperatures T1 to T3 of the respective electric storage devices V1 to V3 as denominators. That is, the duty cycles D1 to D3 are defined as D1=TS/T1, D2=TS/T2, and D3=TS/T3. Moreover, by defining this way, the duty cycle D concerning the electric storage device V having the lowest temperature T becomes 100% and the duty cycles D concerning the rest of the electric storage devices V become values equal to or below 100%.

To be more precise, if T1<T2<T3=60° C.<70° C.<80° C. holds true, then D1 is calculated as 60/60×100=100[%], D2 is calculated as 60/70×100≈86[%], and D3 is calculated as 60/80×100=75[%]

Moreover, it is also possible to provide a step of standing by for a predetermined time period when returning from steps S112 to S101 in the control flow of FIG. 8. The predetermined time period varies depending on the electric storage device V or on a temperature change tendency of an instrument mounted with the power supply apparatus 104 described in Example 4, for example. When the temperature change tendency is small, the predetermined time value may be set to a large value.

By the configuration described above, it is possible to perform control more efficiently by reducing the currents flowing through the electric storage devices V instead of disconnecting the electric storage devices V at the time of rise in the temperature. Moreover, it is possible to homogenize the temperatures of the respective electric storage devices V1 to V3 more appropriately because it is possible to control the FETs 1 depending on relative temperatures instead of using absolute temperatures of the electric storage devices V.

### Example 5

Example 5 will describe a method of suppressing a temperature rise of the electric storage device by using a current detector and a voltage detector without using heat sensitive elements.

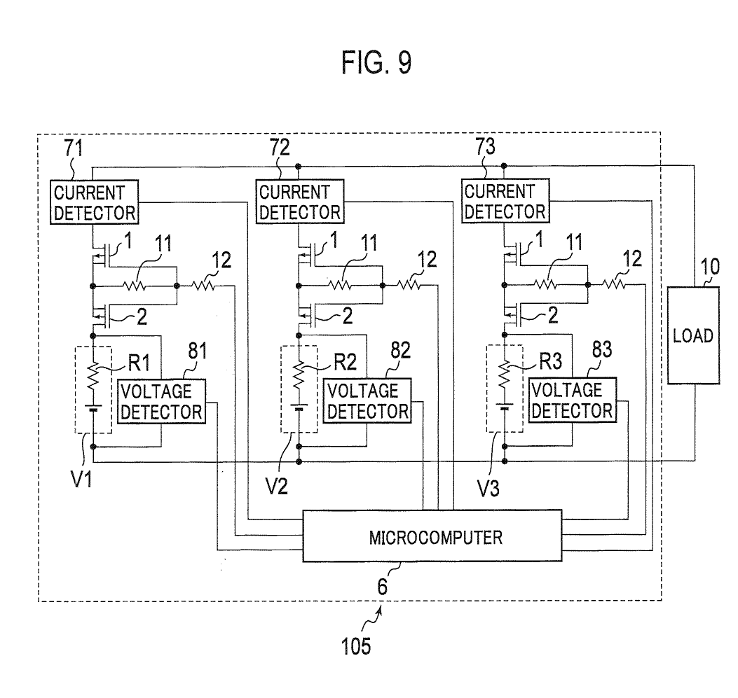

FIG. 9 is a circuit diagram showing Example 5 of the power supply apparatus of the present invention. A power supply apparatus 105 of Example 5 is provided with current detectors 71 to 73 and voltage detectors 81 to 83 instead of the resistances 14 and the thermistors 51 to 53 in the power supply apparatus 104 of the above-described Example 4. The current detectors 71 to 73 are provided on the respective electric storage devices V1 to V3 in series and configured to detect the currents flowing through the respective electric storage devices V1 to V3. Meanwhile, the voltage detectors 81 to 83 are provided on the respective electric storage devices V1 to V3 in parallel and configured to detect voltages on both ends of the respective electric storage devices V1 to V3.

The microcomputer 6 serving as the controller computes the internal resistances R1 to R3 based on relations of calorific values J1 to J3 generated by the respective electric storage devices which are based on the currents detected by the current detectors 71 to 73 and on the voltages detected by the voltage detectors 81 to 83, and performs the PWM control of the FETs 1 and 2 connected to the respective electric storage devices.

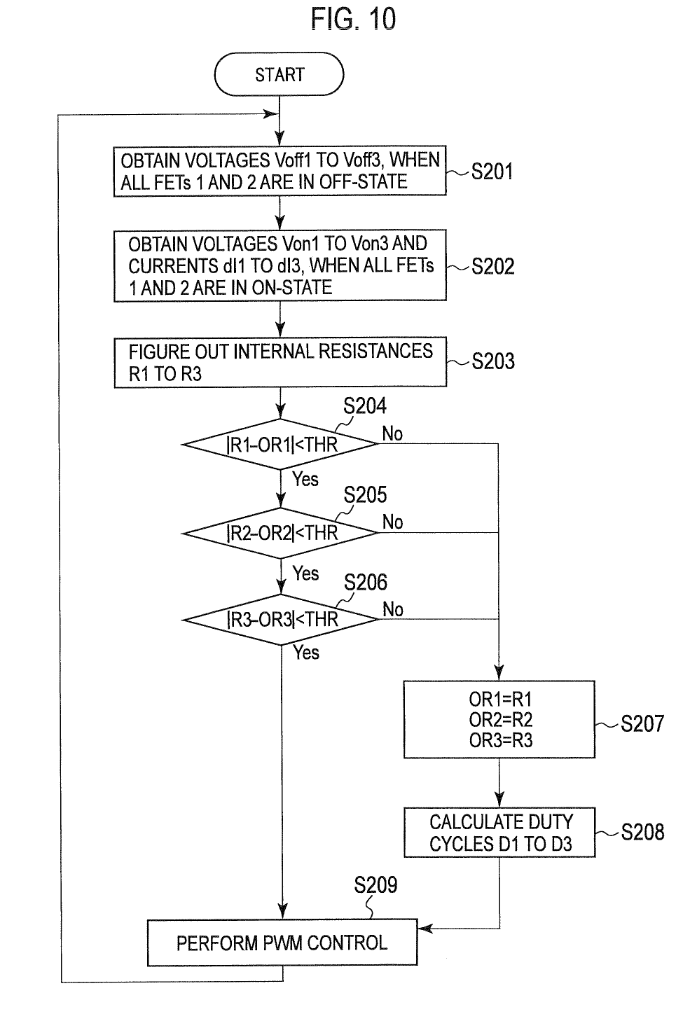

FIG. 10 shows a control flow when using Example 5. Predetermined values are assigned to past internal resistances OR1 to OR3 at a start. At this time, sufficiently large values are assigned to the past internal resistances OR1 to OR3 at the start so as to achieve judgments as NO in steps S204 to S206 to be described later. In step S201, all the FETs 1 and 2 are set to the off-state and voltages Voff1 to Voff3 of the respective electric storage devices V1 to V3 are detected with the voltage detectors 81 to 83. In step S202, all the FETs 1 and 2 are turned on and voltages Von1 to Von3 of the respective electric storage devices V1 to V3 are detected with the voltage detectors 81 to 83. Moreover, currents dI1 to dI3 flowing through the respective electric storage devices V1 to V3 are detected with the current detectors 71 to 73.

In step S203, the internal resistances R1 to R3 are computed by use of the voltages Voff1 to Voff3, the voltages Von1 to Von3, and the currents dI1 to dI3. The internal resistance R1 to R3 can be computed by use of the following equations.

R1=(Voff1−Von1)/dI1

R2=(Voff2−Von2)/dI2

R3=(Voff3−Von3)/dI3 [Equations 1]

The internal resistances R1 to R3 computed in steps S204 to S206 are compared with the past internal resistances OR1 to OR3. The process goes to step S207 if any one of differences of absolute values exceeds a predetermined threshold THR. In step S207, the values of the internal resistances R1 to R3 are respectively assigned to the past internal resistances OR1 to OR3 and then the process goes to step S208. Meanwhile, if the computed internal resistances R1 to R3 are compared with the past internal resistances OR1 to OR3 and all the differences of the absolute values thereof do not exceed the predetermined threshold THR, then the process goes to step S209 to perform the PWM control. Since step S208 is not carried out in this case, the PWM control is performed without changing the duty cycles D1 to D3.

In step S208, the duty cycles D1 to D3 are computed based on the computed internal resistances R1 to R3. The calorific value (such as Joule heat) J of the electric storage device V is obtained by J=RI². Here, R is the internal resistance and I is the current flowing through the electric storage device V. For this reason, the following proportion is obtained by deriving a proportion of the currents I1 to I3 flowing through the respective electric storage devices V1 to V3 under a condition in which the calorific values J1 to J3 of the respective electric storage devices V1 to V3 are mutually equal (i.e., J1=J2=J3).

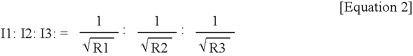

The PWM control controls proportions between the on-states and the off-states of the FETs 1 and 2. Accordingly, assuming that a constantly on-state is defined as 100%, time averages of the currents flowing through the FETs 1 and 2 after a lapse of a sufficient time period become equal to the duty cycles D1 to D3.

In step S209, the PWM control is started by use of the duty cycles D1 to D3 obtained in step S208 and the process returns to step S201. Here, it is possible to achieve the highest output of the duty cycles D1 to D3 by setting the largest proportion to be 100%.

It has been previously described to start after providing the sufficiently large values to the past internal resistances OR1 to OR3 at the start so as to judge NO in the later steps S204 to S206. Instead, it is possible to go to step S201 after performing steps S201, S202, S203, S207, S208, and S209 in advance.

Moreover, it is also possible to provide a step of standing by for a predetermined time period when returning from steps S209 to S201 in the control flow of FIG. 10. By doing so, it is possible to reduce the number of times of setting the switching elements of all of the electric storages devices entirely to the on-state and entirely to the off-state in step S201 and in step S202, and thereby to improve efficiency. The predetermined time period varies depending on the electric storage device V or on a temperature change tendency of an instrument mounted with the power supply apparatus 105 described in Example 4, for example. When the temperature change tendency is small, the predetermined time value may be set to a large value.

By performing the control as described above, it is possible to perform control so as to equalize the calorific values of the respective electric storage devices V1 to V3 without using the elements for temperature detection. Accordingly, it is possible to perform control so as to equalize the temperature rises amount the respective electric storage devices. Moreover, since the calorific values J1 to J3 of the respective electric storage devices V1 to V3 are equalized, it is possible to perform the control before the temperatures become high.

Example 5 has described the contents of computing the internal resistances R1 to R3 based on the calorific values J1 to J3 generated by the respective electric storage devices V1 to V3, which are based on the currents detected with the current detectors 71 to 73 and the voltage detectors 81 to 83, then computing the duty cycles D1 to D3 by use of the obtained internal resistances R1 to R3, and outputting the PWM signal. However, the invention is not limited to this configuration.

For example, it is also possible to prepare a table showing relations among the currents, the voltages, and the duty cycles in advance, to obtain the duty cycles D1 to D3 with reference to this table, and to output the PWM signal. Alternatively, it is possible to prepare the table showing the relations among the currents, the voltages, and the duty cycles in advance and to generate the PWM signal directly by use of the current values and the voltage values.

### Example 6

In Example 6, an electric vehicle including the power supply apparatus according to any of Example 1 to Example 5 will be described with reference to the accompanying drawing.

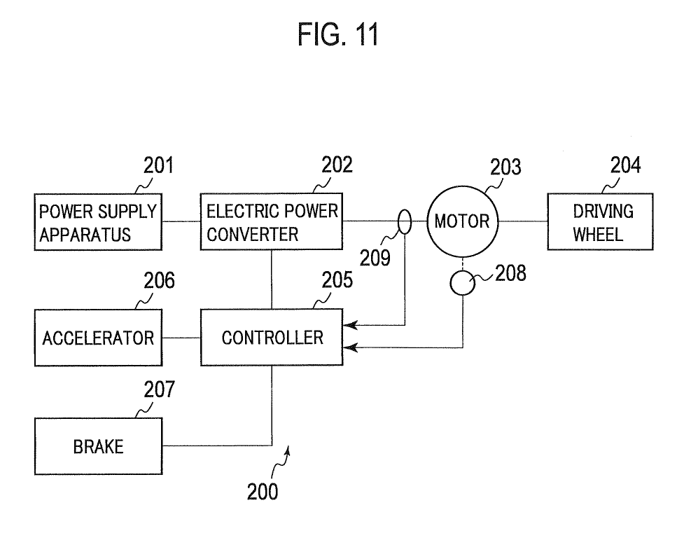

As shown in a configuration diagram of an electric vehicle 200 in FIG. 11, the electric vehicle 200 of Example 6 includes a power supply apparatus 201, an electric power converter 202, an electric motor (motor) 203, a driving wheel 204, a controller 205, an accelerator 206, a brake 207, a rotation sensor 208, and a current sensor 209.

The power supply apparatus 201 is any of the power supply apparatuses 101 to 105 according to Example 1 to Example 5. The electric power from the power supply apparatus 201 is converted by the electric power converter 202 and the converted electric power is supplied to the motor 203.

When driving the motor, the electric power converter 202 is controlled so as to convert the electric power from the power supply apparatus 201 into electric power required by the motor 203 (such as electric power corresponding to an instructed torque). Moreover, when the motor 203 performs regeneration, the electric power converter 202 is controlled by the controller 205 so as to convert the power, generated by regeneration of the motor 203, to be accumulated in the power supply apparatus 201.

The motor 203 generates motive power as the electric power converted by the electric power converter 202 is supplied thereto. The motive power generated by the motor 203 is transmitted to the driving wheel 204.

The controller 205 calculates the instructed torque by using an opening degree of the accelerator 206, revolutions of the motor obtained from the rotation sensor 208, and the like. Moreover, the controller 205 calculates a current instruction value based on the instructed torque thus calculated. The controller 205 controls the drive of the motor by controlling the electric power converter 202 based on a difference between this current instruction value and an output value from the current sensor 209. Moreover, the controller 205 performs regeneration control when the opening degree of the accelerator is equal to or below a predetermined threshold or in response to an operation of the brake 207.

Since the electric vehicle 200 configured as described above applies any of the power supply apparatuses 101 to 105 of Example 1 to Example 5 as the power supply apparatus 201, it is possible to suppress a temperature rise even if the power supply apparatus 201 generates the heat as a result of the supply of the electric power from the power supply apparatus 201 to the motor 203.

Moreover, the power supply apparatus is operable even when output control is performed on the heated electric storage device among the multiple electric storage devices provided in the power supply apparatus. Accordingly, it is still possible to supply the electric power to the electric motor 203.

Meanwhile, even if heat generation of an electric circuit and the like constituting the electric motor 203 or the controller 205 exerts an influence upon the temperature rise of the power supply apparatus 201, it is still possible to suppress the temperature rise of the power supply apparatus 201 by suppressing the temperature by use of the temperatures of the electric storage device inside the power supply apparatus 201.

Although the electric vehicle 200 in Example 6 is not provided with a steering for turning the electric vehicle 200, such a steering may be provided as appropriate. Moreover, a transmission may be provided between the motor 203 and the driving wheel 204.

### Other Modified Examples

The FETs are used as the switching elements in the respective examples. However, the switching elements are not limited to the FETs. For example, it is also possible to use IGBTs (Insulated Gate Bipolar Transistors) or TRIACs (Triode AC Switches). Meanwhile, if the PWM control does not take place as in Example 1 or Example 2, then it is not essential to switch between the on-state and the off-state as fast as the switching element. Accordingly, it is also possible to use switches like relays which are configured to set the on-state and off-state mechanically by providing electric signals.

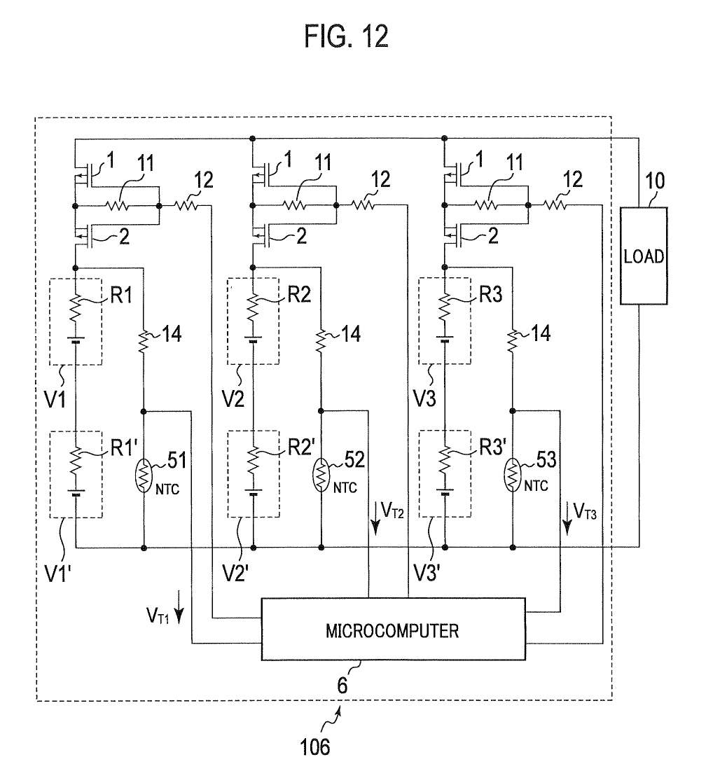

Meanwhile, the single electric storage device is connected in parallel in each of the examples. Instead, multiple electric storage devices connected in series may be provided. To be more precise, as shown in a circuit diagram of FIG. 12 in which the multiple electric storage devices connected in series are applied to Example 4, a power supply apparatus 106 includes electric storage devices V1′ to V3 which are respectively connected to the electric storage devices V1 to V3 of Example 4 in series, for example. In this way, it is possible to provide the power supply apparatus 106 compatible with a load that requires larger output voltage. Note that, although the number of the electric storage devices connected in series is two in FIG. 12, the invention is not limited to this configuration.

Meanwhile, it is also possible to serially connect the power supply apparatuses 101 to 106 of the respective Examples to utilize as a power supply module. In this way, it is possible to provide the power supply apparatus compatible with a load that requires larger output voltage.

Meanwhile, the electric storage devices V1 to V3 in the respective examples can be replaced by the power supply modules and utilized accordingly. By applying this configuration, it is possible to suppress the temperatures of the power supply modules in the case of the temperature rise in the entire power supply modules.

Although the set value of the trip temperature is defined as the single value in Example 4, it is also possible to apply mutually different values to the respective electric storage devices V1 to V3. Meanwhile, instead of performing the control to make the trip temperature equal to the return temperature, the control may be performed to make the temperatures different from each other.

Example 4 has described the method of calculating the duty cycles D1 to D3 and performing the PWM control in the case of exceeding the predetermined temperature TH. However, a configuration may be employed to perform the PWM control by calculating the duty cycles D1 to D3 constantly without using the temperature TH. In this case, a flow configured to execute the operation of step S111 after step S101, and then to return to step S101 after performing step S112 is applied. By doing so, the PWM control is performed while constantly comparing battery temperatures. Accordingly, it is possible to suppress variation in the temperature changes at any time.

Although the single microcomputer 6 is used for performing the control in Examples 4 and 5, each of the electric storage devices V1 to V3 may use a microcomputer instead. In that case, it is preferable to set up the predetermined temperature TH for each of the microcomputers 6 and to perform control while grasping size relations by means of communication between the microcomputers.

Example 5 has described the method of calculating the duty cycles D1 to D3 and performing the PWM control when exceeding the predetermined internal resistance THR. However, a configuration may be employed to perform the PWM control by calculating the duty cycles D1 to D3 constantly without using the internal resistance THR. In this case, a flow configured to execute the operations of steps S201, S202, S203, and S208 and then to return to step S201 after performing Step S209 is applied. By doing so, the PWM control is performed while constantly comparing the internal resistances R1 to R3. Accordingly, it is possible to suppress variation in the temperature rising changes at any time, and thereby to achieve more delicate control.

Meanwhile, the respective examples have described the case of connecting the three electric storage devices V1 to V3 in parallel. However, the number of the electric storage devices to be connected in parallel is not limited only to three.

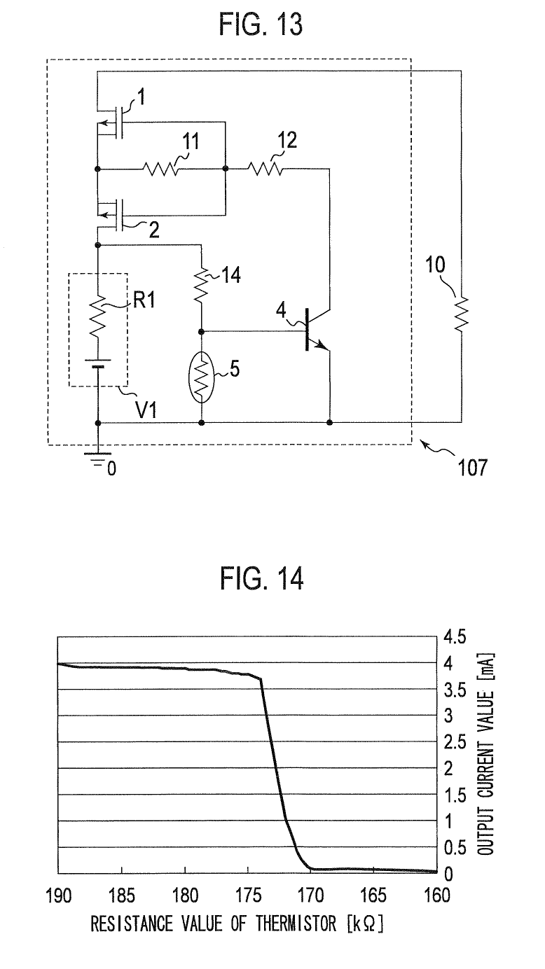

Meanwhile, a power supply apparatus 107 including the electric storage device V1, the FETs 1 and 2, the bipolar transistor 4, the thermistor (NTC) 5, and the resistances 11, 12, and 14 is produced as shown in FIG. 13. Then, output current values from the electric storage device V1 when changing a resistance value of the thermistor 5 are measured. A measurement result of the output current values from the electric storage device V1 is shown in FIG. 14. As shown in FIG. 14, in a case where the resistance value of the thermistor 5 is gradually decreased, the output voltage value from the electric storage device V1 starts gradual reduction from a point when the resistance value of the thermistor 5 reaches a certain value (such as 174 kΩ in FIG. 14), and reaches zero at a point when the resistance value reaches a lower value (such as 170 kΩ in FIG. 14). From this result, it is apparent that the FETs 1 and 2 functioning as the switching elements have a characteristic in which each of the FETs 1 and 2 does not shift from the on-state to the off-state instantaneously but shift gently. Therefore, use of the PTC 3 or the thermistor 5 which achieves gentle variation in the resistance value of the temperature change, and which is applied to the PTC 3 in Example 1, 2 or to the thermistor 5 in Example 3, 4 makes it possible to achieve a gentler shift from the on-state to the off-state in the FETs 1, 2. In this way, reduction of an output current from the electric storage device V corresponding to the FETs 1 and 2 shifting from the on-state to the off-state becomes gentler. Hence, an increase in the output currents from the other electric storage devices V can be made gentler. In other words, it is possible to avoid abrupt load application to the electric storage devices V. Accordingly, deterioration of the electric storage devices V can be suppressed. Moreover, it is possible to suppress sudden changes in the electric power to be supplied to the load 10.

Although the embodiment of the present invention has been described above in detail, it is to be understood that the present invention is not limited only to the above-described embodiment and various modifications can be made within the technical scope as defined in the appended claims.

It is to be noted that the entire contents of Japanese Patent Application No. 2007-119249 (filed on Apr. 27, 2007) are incorporated in this description by reference.

### INDUSTRIAL APPLICABILITY

As described above, the power supply apparatus according to the present invention is useful because it is possible to suppress variation in temperature among the respective electric storage devices even if the configuration of the power supply apparatus or the environmental temperature is unknown.

1. A power supply apparatus provided with a plurality of electric storage devices connected in parallel, comprising:
a temperature detector configured to detect a temperature of each of the plurality of electric storage devices;
a switching element connected to each of the plurality of electric storage devices in series; and
a controller configured to control an on-state and an off-state of the switching element,
wherein the controller sets the switching element to the off-state when the temperature detected by the temperature detector is higher than a predetermined temperature.

2. A power supply apparatus provided with a plurality of electric storage devices connected in parallel, comprising:
a temperature detector configured to detect a temperature of each of the plurality of electric storage devices;
a switching element connected to each of the plurality of electric storage devices in series; and
a controller configured to control an on-state and an off-state of the switching element,
wherein the controller outputs a PWM signal to the switching element on the basis of the temperature detected by the temperature detector, and sets the switching element to the on-state or the off-state in response to a high-state and a low-state of the PWM signal.

3. A power supply apparatus provided with a plurality of electric storage devices connected in parallel, comprising;
a current detector configured to detect a current flowing through each of the plurality of electric storage devices;
a voltage detector configured to detect a voltage of each of the plurality of electric storage devices;
a switching element connected to each of the plurality of electric storage devices in series; and
a controller configured to output a PWM signal to the switching element on the basis of the current detected, by the current detector and the voltage detected by the voltage detector, and to set the switching element to the on-state or the off-state in response to a high-state and a low-state of the PWM signal.

4. The power supply apparatus according to claim 3, wherein the controller outputs the PWM signal having a duty cycle corresponding to an internal resistance of each of the plurality of electric storage devices, on the basis of the current detected by the current detector and the voltage detected by the voltage detector.

5. The power supply apparatus according to claim 1, wherein at least one of the plurality of electric storage devices formed of a plurality of electric storage devices connected in series.

6. An electric vehicle comprising:
the power supply apparatus according to claim 1;
an electric motor configured to generate motive power by use of electric power supplied by the power supply apparatus; and
a driving wheel to which the motive power is transmitted.

7. The power supply apparatus according to claim 2, wherein at least one of the plurality of electric storage devices formed of a plurality of electric storage devices connected in series.

8. The power supply apparatus according to claim 3, wherein at least one of the plurality of electric storage devices formed of a plurality of electric storage devices connected in series.

9. The power supply apparatus according to claim 4, wherein at least one of the plurality of electric storage devices formed of a plurality of electric storage devices connected in series.

10. An electric vehicle comprising:
the power supply apparatus according to claim 2;
an electric motor configured to generate motive power by use of electric power supplied by the power supply apparatus; and
a driving wheel to which the motive power is transmitted.

11. An electric vehicle comprising:
the power supply apparatus according to claim 3;
an electric motor configured to generate motive power by use of electric power supplied by the power supply apparatus; and
a driving wheel to which the motive power is transmitted.

12. An electric vehicle comprising:
the power supply apparatus according to claim 4;
an electric motor configured to generate motive power by use of electric power supplied by the power supply apparatus; and
a driving wheel to which the motive power is transmitted.
